(19) United States
(12) Patent Application Publication
(10) Pub. No.: US 2022/0106117 A1
(43) Pub. Date: Apr. 7, 2022

(54) CONTROL APPARATUS, SYSTEM, LOCKER, AND STORAGE SUPPORT METHOD

(71) Applicant: TOYOTA JIDOSHA KABUSHIKI KAISHA, Toyota-shi (JP)

(72) Inventors: Makoto MATSUSHITA, Ichinomiya-shi (JP); Tomo SASAKI, Toyota-shi (JP); Yui NAKAMURA, Nagoya-shi (JP); Satoshi KOMAMINE, Nagoya-shi (JP); Shuichi SAWADA, Nagoya-shi (JP); Tatsuya SUZUKI, Nagoya-shi (JP)

(73) Assignee: TOYOTA JIDOSHA KABUSHIKI KAISHA, Toyota-shi (JP)

(21) Appl. No.: 17/493,401

(22) Filed: Oct. 4, 2021

(30) Foreign Application Priority Data
Oct. 2, 2020 (JP) 2020-168079

(51) Int. Cl. B65G 1/06; G05D 1/00; G05D 1/02

(52) U.S. Cl. CPC B65G 1/065; G05D 2201/0216; G05D 1/0219; G05D 1/0027

(57) ABSTRACT

A control apparatus includes a controller configured to estimate a time at which a package is to be stored in a locker that is provided with one or more storage compartments in a displaceable manner, and adjust, by the estimated time, a position of a storage compartment in which the package is to be stored.

### CROSS-REFERENCE TO RELATED APPLICATION

This application claims priority to Japanese Patent Application No. 2020-168079, filed on Oct. 2, 2020, the entire contents of which are incorporated herein by reference.

### TECHNICAL FIELD

The present disclosure relates to a control apparatus, a system, a locker, and a storage support method.

### BACKGROUND

Patent Literature (PTL) 1 discloses a locker in which changes can be made to package storage spaces according to sizes of packages.

### CITATION LIST

### Patent Literature

PTL 1: JP H09-108092 A

### SUMMARY

In a locker as described in PTL 1, if a change is made to a package storage space after a package has arrived, it takes time before storing the package.

It would be helpful to reduce time required before storing a package in a locker in which the position of a storage compartment can be changed.

A control apparatus according to the present disclosure includes a controller configured to:

estimate a time at which a package is to be stored in a locker that is provided with one or more storage compartments in a displaceable manner; and

adjust, by the estimated time, a position of a storage compartment in which the package is to be stored.

A storage support method according to the present disclosure includes: estimating, by a control apparatus, a time at which a package is to be stored in a locker that is provided with one or more storage compartments in a displaceable manner; and

adjusting, by the control apparatus by the time, a position of a storage compartment in which the package is to be stored.

According to the present disclosure, it is possible to reduce time required before storing a package in a locker in which the position of a storage compartment can be changed.

### BRIEF DESCRIPTION OF THE DRAWINGS

In the accompanying drawings:

FIG. 1 is a diagram illustrating a configuration of a system according to an embodiment of the present disclosure;

FIG. 2 is a block diagram illustrating a configuration of a control apparatus according to the embodiment of the present disclosure;

FIG. 3 is a flowchart illustrating operations of the system according to the embodiment of the present disclosure;

FIG. 4 is a diagram illustrating “before” position adjustment by the system according to the embodiment of the present disclosure;

FIG. 5 is a diagram illustrating “after” the position adjustment by the system according to the embodiment of the present disclosure; and

FIG. 6 is a flowchart illustrating operations of the system according to a variation of the embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

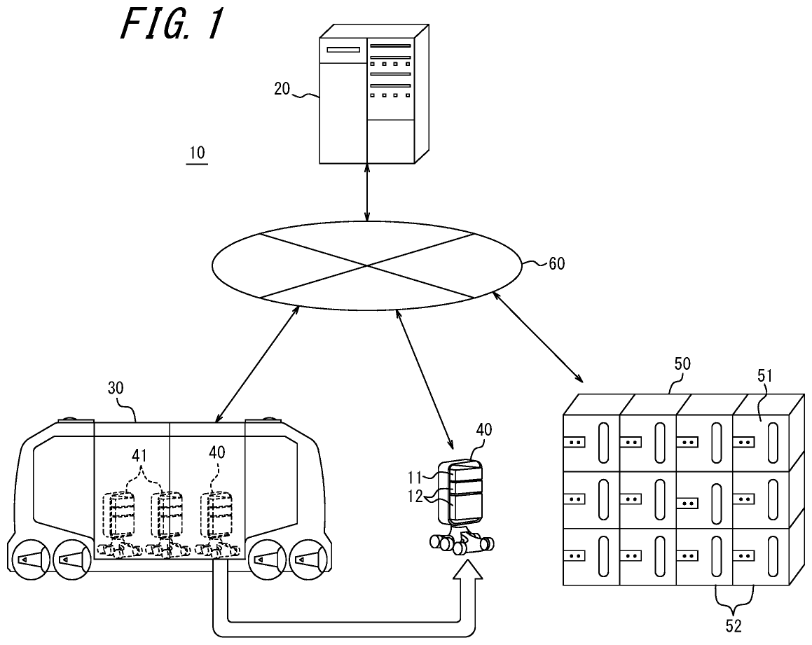

A configuration of a system 10 according to the present embodiment will be described with reference to FIG. 1.

The system 10 includes at least one control apparatus 20, at least one transport vehicle 30, at least one vehicle 40, and at least one locker 50.

The control apparatus 20 is installed in a facility such as a data center. The control apparatus 20 is a computer such as a server that belongs to a cloud computing system or another type of computing system.

The transport vehicle 30 is, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The transport vehicle 30 is an AV in the present embodiment, but may be driven by a driver, or the driving may be automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers. The transport vehicle 30 may be a MaaS-dedicated vehicle. The term “MaaS” is an abbreviation of Mobility as a Service.

The vehicle 40 is, for example, an AGV or a delivery robot. The term “AGV” is an abbreviation of automated guided vehicle. The vehicle 40 is an AV in the present embodiment, but may be driven by remote control. The vehicle 40 is at least one of two or more vehicles 41 transported by the transport vehicle 30 to a spot near where the locker 50 is installed in the present embodiment, but may independently reach the spot near where the locker 50 is installed. That is, as a variation of the present embodiment, the transport vehicle 30 may be omitted.

The locker 50 is installed in an apartment building in the present embodiment, but may be installed in an office building, a train station, or elsewhere. The locker 50 is provided with two or more storage compartments 52, including a storage compartment 51 in which a package 11 is to be stored, in a displaceable manner in the present embodiment, but the number of the storage compartments 52 is not limited to two or more and may be one. The package 11 is at least one of one or more packages 12 carried by the vehicle 40 to the front of the locker 50 in the present embodiment, but may be carried by a person to the front of the locker 50. Each of the storage compartments 52 is, for example, a storage box with a door.

The control apparatus 20 can communicate with the transport vehicle 30, the vehicle 40, and the locker 50 via a network 60. The transport vehicle 30 may be able to communicate with the vehicle 40 directly or via the network 60. The vehicle 40 may be able to communicate with the locker 50 directly or via the network 60.

The network 60 includes the Internet, at least one WAN, at least one MAN, or any combination thereof. The term “WAN” is an abbreviation of wide area network. The term “MAN” is an abbreviation of metropolitan area network. The network 60 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The control apparatus 20 estimates a time Tm at which the package 11 is to be stored in the locker 50. The control apparatus 20 adjusts, by the time Tm, the position of the storage compartment 51 in which the package 11 is to be stored.

According to the present embodiment, the position of the storage compartment 51 can be changed before the package 11 arrives. Therefore, it is possible to reduce time required before storing the package 11.

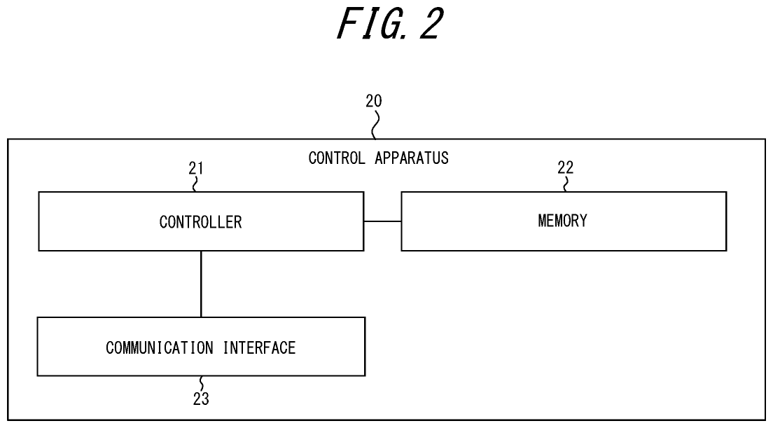

A configuration of the control apparatus 20 according to the present embodiment will be described with reference to FIG. 2.

The control apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, a LAN interface. The communication interface 23 receives data to be used for the operations of the control apparatus 20, and transmits data obtained by the operations of the control apparatus 20.

The functions of the control apparatus 20 are realized by execution of a program according to the present embodiment by a processor serving as the controller 21. That is, the functions of the control apparatus 20 are realized by software. The program causes a computer to execute the operations of the control apparatus 20, thereby causing the computer to function as the control apparatus 20. That is, the computer executes the operations of the control apparatus 20 in accordance with the program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a programmable circuit or a dedicated circuit serving as the controller 21. That is, some or all of the functions of the control apparatus 20 may be realized by hardware.

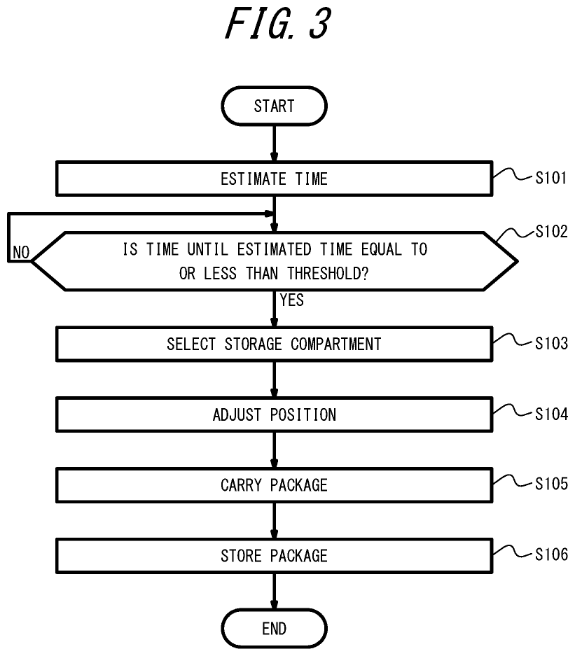

Operations of the system 10 according to the present embodiment will be described with reference to FIG. 3. These operations correspond to a storage support method according to the present embodiment.

In step S101, the controller 21 of the control apparatus 20 estimates a time Tm at which the package 11 is to be stored in the locker 50.

The time Tm may be estimated in any procedure, but in the present embodiment, is estimated in the following procedure.

The vehicle 40 repeatedly measures the position of the vehicle 40 using a GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term

“BDS” is an abbreviation of BeiDou Navigation Satellite System. The term “GLONASS” is an abbreviation of Global Navigation Satellite System. Each time the vehicle 40 measures the position, the vehicle 40 transmits positional data D1a to the control apparatus 20. The positional data D1a is data indicating the measured position.

The communication interface 23 of the control apparatus 20 receives the positional data D1a from the vehicle 40. The controller 21 of the control apparatus 20 acquires the positional data D1a received by the communication interface 23. The controller 21 estimates the time Tm according to the position indicated by the acquired positional data D1a. Specifically, the controller 21 calculates, with reference to map data D1b, the time required from the position indicated by the positional data D1a to where the locker 50 is installed. The map data D1b may be stored in advance in the memory 22 of the control apparatus 20, or may be accumulated in an external system such as an Internet-based GIS. The term “GIS” is an abbreviation of geographic information system. The controller 21 may calculate the required time independently, or may calculate the required time using an external system such as an Internet-based GIS. The controller 21 estimates the time Tm by adding the calculated required time to a current time.

In step S102, the controller 21 of the control apparatus 20 determines whether the time until the time Tm is equal to or less than a threshold Tv. The threshold Tv may be any value, but in the present embodiment, is set to a value that is equal to or greater than the time required to move any storage compartment 52 to any position. Until it is determined that the time until the time Tm is equal to or less than the threshold Tv, the process in step S102 is performed repeatedly. In a case in which it is determined that the time until the time Tm is equal to or less than the threshold Tv, the process in step S103 is performed.

In step S103, the controller 21 of the control apparatus 20 controls the communication interface 23 to transmit request data D3a. The request data D3a is data requesting the locker 50 to transmit status data D3b. The status data D3b is data indicating availability of the locker 50. The communication interface 23 transmits the request data D3a to the locker 50. The locker 50 receives the request data D3a from the control apparatus 20. The locker 50 transmits the status data D3b to the control apparatus 20 in response to the received request data D3a. The communication interface 23 of the control apparatus 20 receives the status data D3b from the locker 50. The controller 21 of the control apparatus 20 acquires the status data D3b received by the communication interface 23. The controller 21 selects the storage compartment 51 from among the two or more storage compartments 52 according to the availability indicated by the acquired status data D3b.

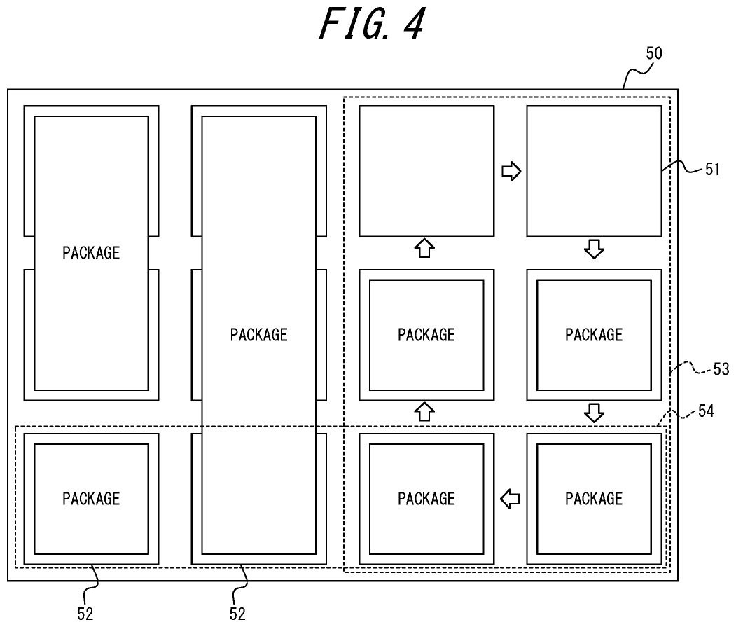

For example, suppose that, as illustrated in FIG. 4, the first and second storage compartments 52 from the right in the top row of the locker 50 are available. The communication interface 23 of the control apparatus 20 receives, as the status data D3b, data indicating that these two storage compartments 52 are available. The controller 21 of the control apparatus 20 selects, as the storage compartment 51, one of the two storage compartments 52 that are indicated to be available by the status data D3b.

In step S104, the controller 21 of the control apparatus 20 adjusts the position of the storage compartment 51 by the time Tm.

The position of the storage compartment 51 may be adjusted in any procedure, but in the present embodiment, is adjusted in the following procedure.

The controller 21 of the control apparatus 20 controls the communication interface 23 to transmit request data D4a. The request data D4a is data requesting the vehicle 40 to transmit height data D4b. The height data D4b is data indicating a height at which the vehicle 40 is to send the package 11 to the locker 50. The communication interface 23 transmits the request data D4a to the vehicle 40. The vehicle 40 receives the request data D4a from the control apparatus 20. The vehicle 40 transmits the height data D4b to the control apparatus 20 in response to the received request data D4a. The communication interface 23 of the control apparatus 20 receives the height data D4b from the vehicle 40. The controller 21 of the control apparatus 20 acquires the height data D4b received by the communication interface 23. The controller 21 adjusts the position of the storage compartment 51 according to the height indicated by the acquired height data D4b.

For example, suppose that, as illustrated in FIG. 4, the first storage compartment 52 from the right in the top row of the locker 50 is selected as the storage compartment 51. The communication interface 23 of the control apparatus 20 receives, as the height data D4b, data indicating a height H1 at which the vehicle 40 is to slide the package 11. The controller 21 of the control apparatus 20 identifies the height H2 of the storage compartment 51 with reference to specification data D4c for the locker 50. The specification data D4c may be stored in advance in the memory 22 of the control apparatus 20 or in an external storage, or may be acquired from the locker 50. In a case in which the identified height H2 is higher than the height H1 indicated by the height data D4b, the controller 21 controls the communication interface 23 to transmit command data D4d. The command data D4d is data commanding the locker 50 to change the position of the storage compartment 51 so that the height H2 coincides with or lowers slightly below the height H1. The communication interface 23 transmits the command data D4d to the locker 50. The locker 50 receives the command data D4d from the control apparatus 20. The locker 50 changes the position of the storage compartment 51 in accordance with the received command data D4d.

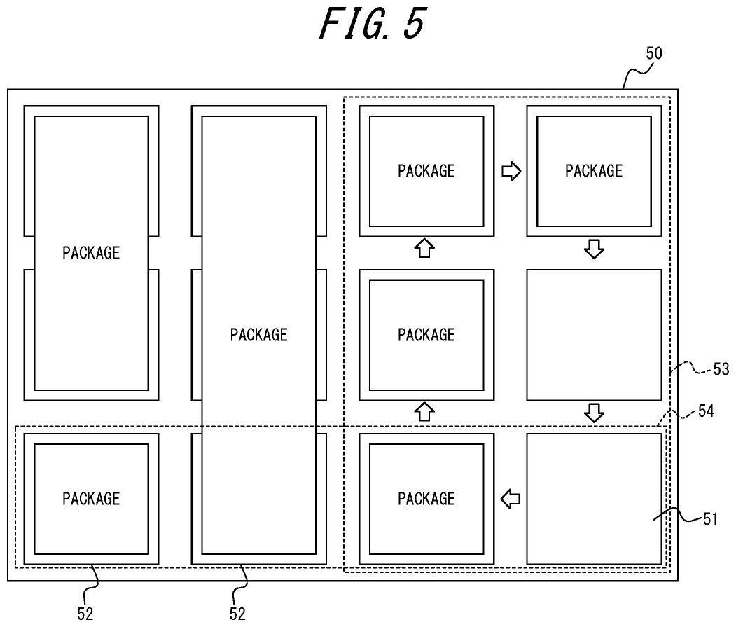

For example, suppose that H1<H2 when the storage compartment 51 is in the top row as illustrated in FIG. 4. The controller 21 of the control apparatus 20 adjusts H2 as a height at which the locker 50 receives the package 11 by moving the storage compartment 51 to the bottom row 54 as illustrated in FIG. 5. As a result, H1≥H2.

In the present embodiment, the locker 50 is provided with, as at least some of the two or more storage compartments 52, a plurality of storage compartments 53 in a circulatable manner. The plurality of storage compartments 53 circulates, for example, in a manner similar to a paternoster. In a case in which the storage compartment 51 is included in the plurality of storage compartments 53, the controller 21 of the control apparatus 20 adjusts the position of the storage compartment 51 by circulating the plurality of storage compartments 53.

The position of the storage compartment 51 may be adjusted according to an attribute of the package 11 instead of or along with the height at which the vehicle 40 is to send the package 11 to the locker 50. In that case, the communication interface 23 of the control apparatus 20 receives attribute data D4e from the vehicle 40. The attribute data D4e is data indicating an attribute of the package 11. The controller 21 of the control apparatus 20 acquires the attribute data D4e received by the communication interface 23. The controller 21 adjusts the position of the storage compartment 51 according to the attribute indicated by the acquired attribute data D4e.

For example, the communication interface 23 of the control apparatus 20 receives, as the attribute data D4e, data indicating the weight of the package 11. The controller 21 of the control apparatus 20 moves the storage compartment 51 to a lower position, as the weight indicated by the attribute data D4e increases.

As a variation of the present embodiment, the controller 21 of the control apparatus 20 may adjust the position of the storage compartment 51 by moving the storage compartment 51 to the bottom row 54 of the locker 50, regardless of the height at which the vehicle 40 is to send the package 11 to the locker 50 or the attribute of the package 11.

In step S105, the controller 21 of the control apparatus 20 controls the communication interface 23 to transmit command data D5a. The command data D5a is data commanding the transport vehicle 30 to transport the two or more vehicles 41 to a spot near where the locker 50 is installed. The communication interface 23 transmits the command data D5a to the transport vehicle 30. The transport vehicle 30 receives the command data D5a from the control apparatus 20. The transport vehicle 30 transports the two or more vehicles 41 to the spot near where the locker 50 is installed in accordance with the received command data D5a. When the transport vehicle 30 arrives at the spot near where the locker 50 is installed, the controller 21 of the control apparatus 20 controls the communication interface 23 to transmit command data D5b. The command data D5b is data commanding the vehicle 40 to carry the package 11 to the front of the locker 50. The communication interface 23 transmits the command data D5b to the vehicle 40. The vehicle 40 receives the command data D5b from the control apparatus 20. The vehicle 40 carries the package 11 to the front of the locker 50 in accordance with the received command data D5b.

In step S106, the controller 21 of the control apparatus 20 controls the communication interface 23 to transmit command data D6a. The command data D6a is data commanding the vehicle 40 to store the package 11 in the locker 50. The communication interface 23 transmits the command data D6a to the vehicle 40. The vehicle 40 receives the command data D6a from the control apparatus 20. The vehicle 40 stores the package 11 in the locker 50 in accordance with the received command data D6a. Specifically, the vehicle 40 slides the package 11 into the storage compartment 51.

As described above, in the present embodiment, the controller 21 of the control apparatus 20 estimates a time Tm at which the package 11 is to be stored in the locker 50 that is provided with two or more storage compartments 52 in a displaceable manner. The controller 21 adjusts, by the estimated time Tm, the position of a storage compartment 51 in which the package 11 is to be stored.

According to the present embodiment, the position of the storage compartment 51 can be changed before the package 11 arrives. Therefore, it is possible to reduce time required before storing the package 11.

According to the present embodiment, in the case of carrying the package 11 using a vehicle 40 such as an AGV, it is possible to make available a position, in the locker 50, into which the package 11 can be easily placed from the vehicle 40.

As a variation of the present embodiment, a person, instead of a vehicle 40, may carry the package 11 to the front of the locker 50. Such a variation will be described.

In step S101, the communication interface 23 of the control apparatus 20 receives positional data D1c from a terminal apparatus held by a person. The positional data D1c is data indicating the position of the person. The terminal apparatus is, for example, a mobile phone, a smartphone, or a tablet. The controller 21 of the control apparatus 20 acquires the positional data D1c received by the communication interface 23. The controller 21 estimates the time Tm according to the position indicated by the acquired positional data D1c.

In step S104, the communication interface 23 of the control apparatus 20 receives height data D4f from the terminal apparatus. The height data D4f is data indicating the height of the person. The controller 21 of the control apparatus 20 acquires the height data D4f received by the communication interface 23. The controller 21 adjusts the position of a storage compartment 51 according to the height indicated by the acquired height data D4f.

In step S105, the controller 21 of the control apparatus 20 controls the communication interface 23 to transmit command data D5c. The command data D5c is data commanding a transport vehicle 30 to transport the person to a spot near where the locker 50 is installed. The communication interface 23 transmits the command data D5c to the transport vehicle 30. The transport vehicle 30 receives the command data D5c from the control apparatus 20. The transport vehicle 30 transports the person to the spot near where the locker 50 is installed in accordance with the received command data D5c. When the transport vehicle 30 arrives at the spot near where the locker 50 is installed, the controller 21 of the control apparatus 20 controls the communication interface 23 to transmit command data D5d. The command data D5d is data commanding the person to carry the package 11 to the front of the locker 50. The communication interface 23 transmits the command data D5d to the terminal apparatus. The terminal apparatus receives the command data D5d from the control apparatus 20. The terminal apparatus displays the received command data D5d to prompt the person to carry the package 11 to the front of the locker 50.

In step S106, the controller 21 of the control apparatus 20 controls the communication interface 23 to transmit command data D6b. The command data D6b is data commanding the person to store the package 11 in the locker 50. The communication interface 23 transmits the command data D6b to the terminal apparatus. The terminal apparatus receives the command data D6b from the control apparatus 20. The terminal apparatus displays the received command data D6b to prompt the person to store the package 11 in the locker 50. Specifically, the terminal apparatus prompts the person to place the package 11 into the storage compartment 51.

According to this variation, in a case in which a short person carries the package 11, it is possible to make available a position, in the locker 50, into which the package 11 can be easily placed.

As another variation of the present embodiment, two or more storage compartments 52 may be provided in the locker 50 in a transformable manner. Such a variation will be described.

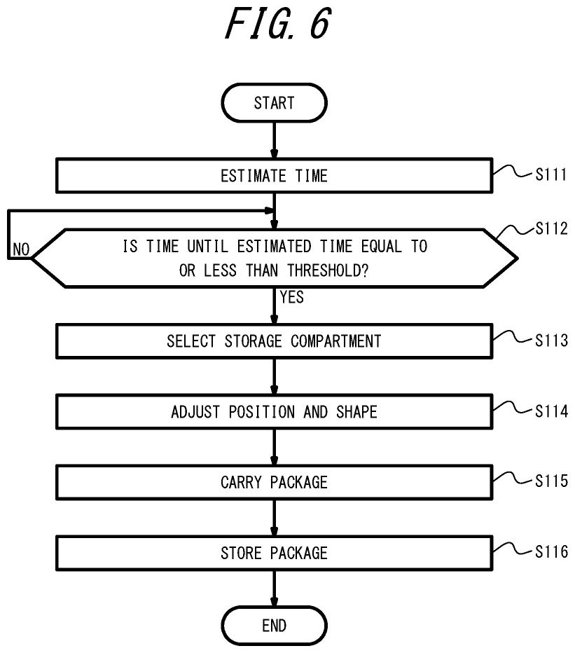

Operations of the system 10 according to this variation will be described with reference to FIG. 6. These operations correspond to a storage support method according to this variation.

The processes in step S111 to step S113 are the same as the processes in step S101 to step S103 of FIG. 3, and thus descriptions thereof are omitted.

In step S114, the controller 21 of the control apparatus 20 not only adjusts the position of a storage compartment 51 but further adjusts the shape of the storage compartment 51 by the time Tm.

The shape of the storage compartment 51 may be adjusted in any procedure, but in this variation, is adjusted in the following procedure.

The communication interface 23 of the control apparatus 20 receives attribute data D4g from the vehicle 40 together with the height data D4b. The attribute data D4g is data indicating an attribute of the package 11. The controller 21 of the control apparatus 20 acquires the height data D4b and the attribute data D4g that are received by the communication interface 23. The controller 21 adjusts the position of the storage compartment 51 according to the height indicated by the acquired height data D4b, and adjusts the shape of the storage compartment 51 according to the attribute indicated by the acquired attribute data D4g.

For example, the communication interface 23 of the control apparatus 20 receives, as the attribute data D4g, data indicating the size or the shape of the package 11. In a case in which there is no space that can accommodate the size or the shape indicated by the attribute data D4g in the storage compartment 51, the controller 21 of the control apparatus 20 expands the space in the storage compartment 51 by moving a partition of the locker 50 to integrate the storage compartment 51 with an adjacent storage compartment 52, similarly to a conventional locker.

The processes in step S115 and step S116 are the same as the processes in step S105 and step S106 of FIG. 3, and thus descriptions thereof are omitted.

According to this variation, a large article can be stored in the locker 50, which has a variable partition. As yet another variation, it may be enabled to store many small articles.

The present disclosure is not limited to the embodiment described above. For example, two or more blocks described in the block diagrams may be integrated, or a block may be divided. Instead of executing two or more steps described in the flowcharts in chronological order in accordance with the description, the steps may be executed in parallel or in a different order according to the processing capability of the apparatus that executes each step, or as required. For example, the process in step S105 of FIG. 3 may be performed in parallel with the processes in step S101 to step S104. The process in step S115 of FIG. 6 may be performed in parallel with the processes in step S111 to step S114. Other modifications can be made without departing from the spirit of the present disclosure.

For example, the control apparatus 20 may be included in a transport vehicle 30. Alternatively, the control apparatus 20 may be included in a vehicle 40. Alternatively, the control apparatus 20 may be included in the locker 50.

1. A control apparatus comprising a controller configured to:
estimate a time at which a package is to be stored in a locker that is provided with one or more storage compartments in a displaceable manner; and
adjust, by the estimated time, a position of a storage compartment in which the package is to be stored.

2. The control apparatus according to claim 1, wherein
the locker is provided with, as the one or more storage compartments, a plurality of storage compartments in a circulatable manner, and
the controller is configured to adjust the position by circulating the plurality of storage compartments.

3. The control apparatus according to claim 1, wherein the controller is configured to acquire height data indicating a height at which a vehicle carrying the package to front of the locker is to send the package to the locker, and adjust the position according to the height indicated by the acquired height data.

4. The control apparatus according to claim 1, wherein the controller is configured to acquire height data indicating a height of a person carrying the package to front of the locker, and adjust the position according to the height indicated by the acquired height data.

5. The control apparatus according to claim 1, wherein the controller is configured to adjust the position by moving the storage compartment in which the package is to be stored to a bottom row of the locker.

6. The control apparatus according to claim 1, wherein the controller is configured to acquire attribute data indicating an attribute of the package, and adjust the position according to the attribute indicated by the acquired attribute data.

7. The control apparatus according to claim 6, wherein the attribute data includes data indicating a weight of the package.

8. The control apparatus according to claim 1, wherein
the one or more storage compartments are provided in the locker in a transformable manner, and
the controller is configured to further adjust, by the time, a shape of the storage compartment in which the package is to be stored.

9. The control apparatus according to claim 8, wherein the controller is configured to acquire attribute data indicating an attribute of the package, and adjust the shape according to the attribute indicated by the acquired attribute data.

10. The control apparatus according to claim 9, wherein the attribute data includes data indicating a size or a shape of the package.

11. The control apparatus according to claim 1, wherein the controller is configured to acquire positional data indicating a position of a vehicle carrying the package to front of the locker, and estimate the time according to the position indicated by the acquired positional data.

12. The control apparatus according to claim 1, wherein the controller is configured to acquire positional data indicating a position of a person carrying the package to front of the locker, and estimate the time according to the position indicated by the acquired positional data.

13. A system comprising:
the control apparatus according to claim 1; and
the locker.

14. A locker comprising the control apparatus according to claim 1.

15. A storage support method comprising:
estimating, by a control apparatus, a time at which a package is to be stored in a locker that is provided with one or more storage compartments in a displaceable manner; and
adjusting, by the control apparatus by the time, a position of a storage compartment in which the package is to be stored.

16. The storage support method according to claim 15, wherein
the locker is provided with, as the one or more storage compartments, a plurality of storage compartments in a circulatable manner, and
the adjusting includes circulating the plurality of storage compartments.

17. The storage support method according to claim 15, further comprising carrying, by a vehicle, the package to front of the locker,
wherein the adjusting includes adjusting the position according to a height at which the vehicle is to send the package to the locker.

18. The storage support method according to claim 15, wherein the adjusting includes adjusting the position according to a height of a person carrying the package to front of the locker.

19. The storage support method according to claim 15, wherein the adjusting includes moving the storage compartment in which the package is to be stored to a bottom row of the locker.

20. The storage support method according to claim 15, wherein
the one or more storage compartments are provided in the locker in a transformable manner, and
the adjusting further includes adjusting, by the time, a shape of the storage compartment in which the package is to be stored.
